(19) United States
(12) Patent Application Publication
(10) Pub. No.: US 2017/0148122 A1
(43) Pub. Date: May 25, 2017

(54) Method for Certifying Residential Cleaning Professionals and Basic Operating a Residential Cleaning Business

(71) Applicant: Heba Elmoslimany, Toronto (CA)

(72) Inventor: Heba Elmoslimany, Toronto (CA)

(21) Appl. No.: 15/361,189

(22) Filed: Nov. 25, 2016

Related U.S. Application Data
(60) Provisional application No. 62/259,476, filed on Nov. 24, 2015.

(51) Int. Cl. G06Q 50/20; G09B 5/00; G09B 7/00; G06Q 30/00

(52) U.S. Cl. CPC G06Q 50/2057; G06Q 30/018; G09B 5/00; G09B 7/00

(57) ABSTRACT

A method of certified training cleaning professionals as well as method of operating a cleaning business is provided herein including a computer configured to track training, certification of residential cleaning professionals wherein said training and certifications include theoretical and practical components.

### INDEX TO RELATED APPLICATIONS

This application is a non-provisional of and claims benefit to U.S. Provisional Patent Application Ser. No. 62/259,476 filed Nov. 24, 2015 the disclosure of which is incorporated herein by reference in its entirety.

### BACKGROUND OF THE INVENTION

A major problem that faces franchise owners e.g. Molly Maid, is attracting and sustaining workers; this has been discussed intensively many times in conferences and one on one with business advisors.

Additionally, the resources, time, effort and money each franchise owner spends on training new work candidates, that may leave abruptly or shortly, does strain the franchise owners at business and personal level. Going through this vicious circle repeatedly on their own is strenuous and stressful as expressed by many.

Furthermore, going to employment agencies to look for potential workers is not always fruitful and often it leads to not getting people who are dedicated or committed to work as cleaners for a company; and also this will need to be supplemented by bounding contract to the company brand name that provides it.

While many industries provide an ‘industry standard’ relating to the education and training of industry workers; yet the cleaning industry has no such established standard. There are many companies that provide residential cleaning services on on-going and contract bases to clients however, short of a client saying a job was completed correctly or a job was unsatisfactory, there is no way to assure the level of education and proficiency of the current workers in this industry, nor if the outcome is compliant with standards of basic or advanced residential cleaning. The present invention addresses this proficiency.

### SUMMARY OF THE INVENTION

In one embodiment, the present invention includes the providing of a certified residential cleaning course which is very helpful to, and can attract serious candidates who wish to have a career in the cleaning business; accordingly it can help filter away a significant number of those who come by as temporary or not committed to working in residential cleaning as a career or as people who have other plans; which is a concern for long term planning in residential cleaning industry.

Asking franchises/businesses of residential cleaning industry about the most important problem in their field, they apparently meet a chronic frequently encountered significant problem which is the ‘lack of immediate availability of qualified residential cleaners who are thoroughly trained and are available to work instantly’. High turnover of residential cleaners and the difficulty to find immediate qualified replacement have a negative impact on their business; and also affect the credibility and reliance on them in addition to the costs of losing business as a consequence. This needed a pragmatic solution that is a win-win to all parties.

Despite being a disturbing problem that affects not only franchise/business owners, but also the clients as well yet it was not approached effectively to find a root cause solution before. This is how the present invention came and it aims to solve this problem by creating the new category of ‘certified residential cleaners’ via teaching the course that generates readily trained and informed residential cleaners ready to work around the clock.

The present invention will resolve the significant problem in the residential cleaning service industry; which is the ‘lack of immediate availability of qualified residential cleaners who are thoroughly trained and are available to work instantly’, which composes number one complaint from franchise/business owners in the residential cleaning industry.

In the residential cleaning industry, clients are always there and the need for residential cleaning is a continuously thriving business around the clock. There is always a need for a clean on weekdays, weekends, mornings, afternoons and sometimes in the evening, let aside during holidays. The business model for residential cleaning is there and it can change flexibly from one location to the other. However, the residential cleaning industry relies on the availability of ready to work residential cleaners, which is a challenge as aforementioned.

The problem manifests if the working force is disturbed for one reason or the other with no immediate alternative availability of qualified replacement of residential cleaning professionals, which exerts short and long term negative impact on the residential cleaning service. From my knowledge of owners of residential cleaning services, the franchise owners confirmed how they spend extensive amount of time, money and effort to train residential cleaners and it hurts them badly when the service is disrupted after that due to one or more workers not showing up to work or reporting sick or any other reason while a client is booked and waiting for the clean.

The present invention creates a sustainable constant pool of available trained/certified professional residential cleaners, who can be deployed immediately and thus reassuring the continuity of the residential cleaning service and no interruption of business or decrease in the revenue.

The structure of the residential cleaning services can accommodate the results of my idea (immediate availability of certified professional residential cleaners), through implementing different form of contracts between franchise/businesses and certified professional residential cleaners and/or the patterns of hiring and the incentives. Not only that but my invention may also help creating a supporting system business of computer data base management system (new opportunity for a new line of IT business that supports it and liaises it with residential cleaning service sector) to allow immediate access to certified trained residential cleaning professionals and timely communication with the residential cleaning companies. This indeed allows the residential cleaning business to have seamless continuity of service, gains and expansion of business, through obtaining a standardized quality of residential cleaning service all the time via the certified residential cleaning professionals.

The present invention also allows the workers the choice to work as independent individually certified residential professional cleaners or within a company frame.

The present invention of creating ‘certified residential cleaning course’ aims to teach/prepare professional cleaners via thoroughly educating the candidates about multiple aspects of the residential cleaning service.

### Benefits

The present invention is beneficial in multiple ways, including, but not limited to:

To the cleaning services industry:
a—As a business continuity measure, this invention will provide immediate availability of ready to work professional residential cleaners which guarantees business continuity and avoids business interruption which is a main concern in residential cleaning industry (franchises, businesses, etc).
b—It saves residential cleaning businesses and franchises' a great amount of effort, time and money spent on repeated frequent training sessions of new cleaners and the constant challenges met with a process of new hiring with new contracts along with the costs of follow up after training as well.
c—It removes the uncertainty in scheduling which promotes more accurate service planning and thus allows increase in sales, expansion of business hours and also allows expanding business locations.
-d—Additionally, one of the major advantages of implementing this invention is that it guarantees high quality of cleaning regardless who is cleaning (all certified residential cleaners are to have the same skills and can manage any challenges in different work scenarios according to their certificate training).

### -2—To the Cleaners:

It allows them to obtain a certificate of having gone through that course and training which makes it much easier to get immediate hiring and finding a job to be almost guaranteed. Also it empowers the cleaners via knowledge and getting the certificate that some of them can even teach the course later on. It helps those looking for part time and full time work at the same time. Furthermore such a certificate course may attract a significant portion of new arriving immigrants who wish to get into the career of cleaning through a credible and trust worthy program that helps them with their settlement phase.

-3—To teaching institutes:

Vocational schools that will have this certificate course taught, will be able to generate income and have a business opportunity (see also #4). Also teaching this certificate course at the vocational institute may allow them to receive some form of government funds/grants through various governmental programs similar to other programs as in Personal Support Workers industry for example ,and likewise programs that can be supported by government grants.

-4—To cleaning product/equipment companies The creation of this course can allow them to have new line of business via providing supplies and equipment for training purpose to run the course, and it can be also an idea on the table if they want to sponsor the certificate course on their own one time or more in liaison with advertising program or vice versa. (see also #5)

### -5—To Cleaning Products/Equipment and Marketing Companies

Classes of this certificate course create a new opportunity for advertising companies to market new cleaning products or also participate in sponsoring course classes.

Finally, it is worth to point that also employment agencies can direct new candidates to this program, where it would be taught, as a bridge to get them into a professional career that they can grow within with more confidence; and even those looking for part time work in residential cleaning can be integrated efficiently and will not be a challenge to residential cleaning businesses or franchise as they are trained and ready to work even as part time, as when they leave they are replaceable by other readily trained certified residential cleaners who have gone through the same certifying course

### Certification Course Content

This idea/invention (the course/method of certifying qualified residential cleaners) can be sold to as mentioned the vocational institutes or the cleaning products/equipment companies, to gain a significant business and income through running the certificate course.

The certification course is conducted through 12 weeks classes that teach and is not limited to:

Various skills of cleaning
Dry cleaning versus wet cleaning skills
Work place safety standards
Understanding and managing cleaning products/equipment properly and safely
Customer service
Time management
Team management
Conflict resolution
Basic business management aspects
Other skills that can be further customized through a flexible structure which can suite various demographic characters, cultures, operating structures and needs of various sections of a city or a town in any country, and more.2

Example: language skills as an adjuvant supplement, which can help in certain locations with non English speaking workers.

Learning of the various course content can be conducted through computer based program and explanation of various key points of learning can be done using simulated computer based environment that mimics various working scenarios, and practical training occurs in a built in mock house environment.

Computer based written and practical exams take place at the end of the certification course.

The cleaning business will benefit at many levels from this ‘certified residential cleaning course’, to create sustainability in the work force which is half of the success of the business. Additionally it will help residential cleaning businesses to get the candidates to commit to learn various aspects about cleaning, including and not limited to the procedure, the cleaning products the cleaning equipment and utensils, health and safety, customer service, managing various scenarios, dealing with work generated stress and more.

It may be a pioneering idea, but in addition to its numerous benefits, it does give a professional leverage as well to a relatively significant sector of potential workers who had faced some career challenges or stopped their education at one point or the other as it helps them gain confidence, experience and getting accredited through this certified program.

On the other side not only will this attract loyalty of the workers and builds enthusiasm but also it can create loyalty of customers who will indeed appreciate Professional residential cleaners than one timers who may have been inconsistent and were not trained adequately. This also can create a better front with insurance and helps towards creating jobs at local, provincial and may be country level too.

In one embodiment, part of the course should be customer service (solving issues with clients, dealing with diverse range of customers, etc.).

In one embodiment, a touch of time management (to help them learn planning a work day including traffic).

In one embodiment, there is a practicum including a computer simulated component of various scenarios and practical mock house environment for training in the class.

In one embodiment, the present invention is a method for certifying residential cleaning professionals and basic operating residential cleaning business aspects, said method comprising the steps of:

providing a computer based program configured to track and perform tasks relating to certifying cleaning professionals; said tasks comprising:
providing a certified residential cleaning course;
tracking enrollment, progress and completion of the certified residential cleaning course;
configuring said residential cleaning training course with an each of an academic component to educate students according to course content about detailed cleaning methodology, work environment health and safety, detailed information about the material used in cleaning, equipment parts assembly with maintenance are taught using a computer based program and practical component including computer simulated scenarios that are often met in residential cleaning environment including actual practical cleaning training in a mock home environment;
conducting an end of course test to evaluate progress as a requirement to graduate the course and become certified residential cleaning professional, is done with about 50 to 75% via computer evaluating academic knowledge of cleaning and various simulated scenarios met in house cleaning environment and a remaining 25% is done through practical exam to test proficiency; and
optionally, assembling a list of certified persons who have completed said course;
   assigning said certified person to a third party established data base liaison website that interlinks between certified residential cleaning professionals and various residential cleaning businesses and franchises.

In one embodiment, the course includes providing training in at least one of chemical use, chemical safety, equipment operation, equipment maintenance, equipment safety, environment evaluation, green cleaning options, and combinations thereof.

In one embodiment, the list of certified persons who have completed said course includes providing said list to a third entity independent of an entity administering said course.

In one embodiment, the method is further comprising the step of querying said list for completion of a specific training course and assembling a list based on said querying.

In one embodiment, the present invention is a method for certifying residential cleaning professionals and basic operating residential cleaning business aspects, said method consisting essentially of the steps of:

providing a computer based program configured to track and perform tasks relating to certifying cleaning professionals; said tasks consisting essentially of:
providing a certified residential cleaning course;
tracking enrollment, progress and completion of the certified residential cleaning course;
configuring said residential cleaning training course with an each of an academic component to educate students according to course content about detailed cleaning methodology, work environment health and safety, detailed information about the material used in cleaning, equipment parts assembly with maintenance are taught using a computer based program and practical component including computer simulated scenarios that are often met in residential cleaning environment including actual practical cleaning training in a mock home environment;
conducting an end of course test to evaluate progress as a requirement to graduate the course and become certified residential cleaning professional, is done with about 50 to 75% via computer evaluating academic knowledge of cleaning and various simulated scenarios met in house cleaning environment and a remaining 25% is done through practical exam to test proficiency; and
assembling a list of certified persons who have completed said course;
   assigning said certified person to a third party established data base liaison website that interlinks between certified residential cleaning professionals and various residential cleaning businesses and franchises.

### DETAILED DESCRIPTION OF THE PREFERRED EMBODIMENT

The present invention provides a method for providing certification and training to establish certified residential cleaning professionals. Persons seeking certification will go through a training course that will include computer based classroom education, practical training, computer based written examinations, and practical examinations.

Primarily, the topic of cleaning materials is to be covered which can include, for example, proper usage, handling, storing and safety of cleaning products. This course will also include important safety information relating to incompatible cleaning products. One such example would be the dangers of mixing certain commonly used cleaning components such as ammonia and chlorine-based cleaning components. Such mixtures can produce noxious and sometimes deadly reaction products. Additionally, topics such as cleaning with natural/green products and the relative safety and handling of these products will also be covered. As one particular example, a clogged drain can be unclogged with a commercial chemical drain unclogging liquid. Alternatively, some drain clogs can be unclogged utilizing a mixture of household baking soda and vinegar.

Additionally, the course will cover proper usage, handling, storage, safety and maintenance of cleaning equipment. Cleaning equipment includes but is not limited to common household equipment such as vacuum cleaners and the like. Additionally, it can also include more sophisticated equipment, including but not limited to machines such as floor buffers and carpet shampooers.

This course will include information relating to the requirements of a first-time clean as opposed to a maintenance clean. Included with the first-time clean and maintenance clean components are various requirements relating to dry clean and wet clean procedures. As previously stated, a practical portion of the course will include supervised exercises to ensure that the objects of the course are being properly conveyed to the course participants. One advantage of a course structured such as this includes an awareness of creating a safe work environment. This includes identification and remediation of any unsafe condition resulting from the cleaning or discovered while cleaning. Optionally, certified residential cleaning professionals will go through a thorough background check which is a pre-requisite before being hired, to ensure they are immediately ready to work after they graduate this course. It is contemplated that the course be conducted through an established education institution, including trade schools, community colleges, and the like.

Currently, organizations that provide contract residential cleaning services have no particularized way of standardizing the quality and training of their services. The present invention includes a method for training and providing standardised residential cleaning services, method providing the steps of: enrolling a person in a residential cleaning course; providing an intensive thorough residential cleaning course, including academic and practical training for a residential cleaning worker; certifying said worker after completion of the course; assembling a list of certified workers; and providing said certified workers to a data base system established in particular to support this course and acts as a direct liaison with residential cleaning business and franchises. It is contemplated that the method of the present invention provides a needed mechanism whereby a prospective employer or client is assured of a high quality standardized level of efficiency of each individual worker.

While the invention has been described in its preferred form or embodiment with some degree of particularity, it is understood that this description has been given only by way of example and that numerous changes in the details of construction, fabrication and use, including the combination and arrangement of parts, may be made without departing from the spirit and scope of the invention.

What is claimed is:

1. A method for certifying residential cleaning professionals and basic operating residential cleaning business aspects, said method comprising the steps of:
providing a computer based program configured to track and perform tasks relating to certifying cleaning professionals; said tasks comprising:
providing a certified residential cleaning course;
tracking enrollment, progress and completion of the certified residential cleaning course;
configuring said residential cleaning training course with an each of an academic component to educate students according to course content about detailed cleaning methodology, work environment health and safety, detailed information about the material used in cleaning, equipment parts assembly with maintenance are taught using a computer based program and practical component including computer simulated scenarios that are often met in residential cleaning environment including actual practical cleaning training in a mock home environment;
conducting an end of course test to evaluate progress as a requirement to graduate the course and become certified residential cleaning professional, is done with about 50 to 75% via computer evaluating academic knowledge of cleaning and various simulated scenarios met in house cleaning environment and a remaining 25% is done through practical exam to test proficiency; and
optionally, assembling a list of certified persons who have completed said course;
assigning said certified person to a third party established data base liaison website that interlinks between certified residential cleaning professionals and various residential cleaning businesses and franchises.

2. The method of claim 1 wherein said course includes providing training in at least one of chemical use, chemical safety, equipment operation, equipment maintenance, equipment safety, environment evaluation, green cleaning options, and combinations thereof.

3. The method of claim 1 where said providing a list of certified persons who have completed said course includes providing said list to a third entity independent of an entity administering said course.

4. The method of claim 1 further comprising the step of querying said list for completion of a specific training course and assembling a list based on said querying.
